(19) United States
(12) Patent Application Publication
(10) Pub. No.: US 2021/0101822 A1
(43) Pub. Date: Apr. 8, 2021

(54) BLOWER BOX FOR THERMAL PRESTRESSING OF GLASS PANES

(71) Applicant: SAINT-GOBAIN GLASS FRANCE, COURBEVOIE (FR)

(72) Inventors: Peter SCHILLINGS, Eschweiler (DE); Achim ZEICHNER, Herzogenrath (DE); Luigi MAZZEO, Herzogenrath (DE); Lutz GEHNEN, Aachen (DE); Bernd SCHNEIDER, Eschweiler (DE)

(21) Appl. No.: 16/608,010

(22) PCT Filed: May 28, 2018
(86) PCT No.: PCT/EP2018/063877

§ 371 Date: Oct. 24, 2019

(30) Foreign Application Priority Data
Jul. 21, 2017 (EP) 17182540.9

(51) Int. Cl. C03B 27/04; C03B 27/044

(52) U.S. Cl. CPC C03B 27/0404; C03B 23/023; C03B 27/0442

(57) ABSTRACT

A blower box for thermal prestressing of glass panes, includes a stationary part having a cavity and a gas feed line connected to the cavity, and at least one closure element having a plurality of nozzles connected to the cavity for applying an air flow to a surface of a glass pane, wherein the at least one closure element is connected to the stationary part at least via a connection element of variable length, and the at least one closure element is movable relative to the stationary part such that the distance between the closure element and the stationary part is variable, and the blower box is equipped with a system for moving the at least one closure element.

The invention relates to a blower box and an apparatus containing it for thermal prestressing of glass panes, as well as a prestressing method performed therewith.

The thermal hardening of glass panes has long been known. It is frequently also referred to as thermal prestressing or tempering. Merely by way of example, reference is made to the patent documents GB 505188 A, DE 710690 A, DE 808880 B, DE 1056333 A from the 1930s to the 1950s. A glass pane heated to just below softening temperature is impinged upon by an air flow that results in rapid cooling (quenching) of the glass pane. As a result, a characteristic stress profile develops in the glass pane, wherein compressive stresses predominate on the surfaces and tensile stresses in the core of the glass. This influences the mechanical properties of the glass pane in two ways. First, the fracture stability of the pane is increased and it can withstand higher loads than a non-hardened pane. Second, glass breakage after penetration of the central tensile stress zone (perhaps by damage from a sharp stone or by intentional destruction with a sharp emergency hammer) does not occur in the form of large sharp edged shards, but rather in the form of small, blunt fragments, significantly reducing the risk of injury.

Due to the above-described properties, thermally prestressed glass panes are used in the vehicle sector as so-called “single-pane safety glass”, in particular as rear windows and side windows. In particular, in the case of passenger cars, the panes are typically bent. The bending and prestressing are done in combination: the pane is softened by heating, brought into the desired bent shape, and then impinged upon by the cooling air flow, thus creating the prestressing. Here, so-called “blower boxes” (quench box, quench head) are used, to which the air flow is supplied by strong fans and which divide the air flow as uniformly as possible over the pane surfaces.

Various types of blower boxes are known. Relatively simple blower boxes are completed by a nozzle plate, in which the nozzles, by means of which the glass pane is impinged upon by air, are distributed as a two-dimensional pattern. Blower boxes of this type are known, for example, from GB 505188 A, U.S. Pat. No. 4,662,926 A, and EP 0002055 A1. In more complex blower boxes, the air flow is divided into different channels, which are completed in each case by a nozzle strip. The nozzle strips have a single row of nozzles that are directed at the glass pane and which, again, divide the air flow of each channel and impinge upon the glass pane with the air flow that is now distributed over a large area. Blower boxes of this type with nozzle strips are disclosed, for example, in DE 3612720 C2, DE 3924402 C1, and WO 2016054482 A1.

If the glass panes to be prestressed are planar or cylindrical, i.e., bent along only one spatial direction, the blower boxes, together with the nozzles, can remain stationary (in terms of their distance from the glass pane), whereas the glass panes to be prestressed are conveyed successively into the intermediate space between the blower boxes and out of the intermediate space again. Also known are blower boxes that are connected to their nozzles via connection elements of variable length. As a result, the positioning of the nozzles can be adjusted such that pane types of different shape, i.e., in particular different dimension and different curvature, can be prestressed with the same apparatus. The positioning of the nozzles is then initially adjusted to the pane type to be prestressed. The prestressing of the pane of this pane type is then done for the entire production series with this setting, with the the distance of the nozzles from the prestressing position of the glass panes remaining invariable. Blower boxes of this type are known, for example, from EP0421784A1, U.S. Pat. Nos. 4,314,836A, 4,142,882, and DE1056333B1. The transport of the glass panes can be done horizontally, lying on rollers, as in EP0421784A1; vertically suspended on tongs, as in U.S. Pat. No. 4,142,882 and DE1056333B1; or horizontally, lying on a frame mould, as in U.S. Pat. No. 4,314,836A.

Known from U.S. Pat. No. 6,722,160B1 is an apparatus for prestressing bent glass panes, wherein the bent glass pane is transported by means of rollers through an array of nozzles. At a given time, the glass pane is in each case impinged upon by an air flow from only a subset of all nozzles. The positioning of those rollers and nozzles allocated to the glass pane at a specific moment is adapted to the shape of the pane by simultaneous vertical displacement. A similar apparatus is known from JP2004189511A. Since the adaptation to the shape of the pane is achieved by displacement of the rollers relative to one another, this adaptation relates only to the curvature of the pane along the spatial direction perpendicular to the direction of extension of the individual rollers. Adaptation to the curvature of the pane along the spatial direction parallel to the direction of extension of the individual rollers is not possible. Thus, this apparatus is likewise optimally usable only for cylindrically curved panes.

Since vehicle windows are typically bent in both spatial directions, i.e., are, so to speak, bowl-shaped, it is not possible to move them between two stationary blower boxes for prestressing. The nozzle outlet surface has, in fact, a curvature that is adapted to that of the glass pane such that all nozzle openings are substantially the same distance from the pane surface. In order to be able to bring the curved pane between the complementarily curved blower boxes, the blower boxes must be situated in a relatively widely spaced state. In this state, the blower boxes would then be, at least locally, too far from the pane surface, which would too greatly reduce the prestressing efficiency. The nozzle openings are arranged as close as possible to the pane surface in order to achieve optimum prestressing efficiency. The curved glass pane is, consequently, typically moved between an upper and a lower blower box; the blower boxes are then moved toward one another and the pane surfaces for prestressing. It is crucial for the approach to be done as quickly as possible so the glass does not already cool significantly before prestressing. After the prestressing, the blower boxes are again moved away from one another in order to be able to move the glass pane out of the intermediate space. The entire apparatus with the two blower boxes is often referred to as a prestressing station.

The constant movement of the heavy blower boxes implies a high load on the prestressing apparatus that makes complicated movement mechanisms necessary and is energy-intensive. In addition, each blower box is only suitable for a certain pane type with which the nozzle plates or the nozzle strips are coordinated in terms of geometric shape (size and curvature). When a different pane type is to be prestressed, changing out the complete blower boxes is necessary, which is time-consuming and labour-intensive.

The object of the present invention is to provide a blower box for thermal prestressing of glass panes that is more flexible to use, significantly reduces the effort during conversion between different pane types, and relies on less complicated mechanical movement mechanisms.

The object is accomplished according to the invention by a blower box in accordance with claim 1. Preferred embodiments are evident from the dependent claims.

The blower box according to the invention is used to impinge upon the surface of a glass pane for thermal prestressing. The blower box is an apparatus having an inner cavity and a gas feed line that is connected to the cavity and via which a gas flow can be introduced into the cavity in the interior of the blower box. The gas flow is typically produced by means of a fan or a plurality of fans connected in series. Preferably, the gas feed line can be closed, for example, by means of a slide or a flap such that the gas flow into the inner cavity can be interrupted without switching off the fans themselves.

The blower box according to the invention comprises a stationary part having a cavity and a gas feed line connected to the cavity. The cavity is surrounded by a cover to which the gas feed line is connected and which has at least one outlet opening. The blower box also includes at least one movable closure element, which is provided to close the at least one outlet opening, and which is equipped with a plurality of nozzles. The nozzles are connected to the cavity or linked to the cavity such that gas can flow out of the cavity through the nozzles to impinge upon the surface of the glass pane with an air flow.

The blower box thus divides the gas flow from the gas feed line with a comparatively small cross-section via the nozzles onto a large effective area. The nozzle openings constitute discrete gas outlet points that are, however, present in large numbers and are uniformly distributed such that all regions of the surface are cooled substantially simultaneously and uniformly such that the pane is provided with homogeneous prestressing.

The nozzles are bores or passages that extend through the entire closure element. Each nozzle has an entry opening (nozzle inlet), through which the gas flow enters into the nozzle, and an opposite outlet opening (nozzle opening), through which the gas flow exits from the nozzle (and the entire blower box). The surface of the closure element with the entry openings faces the cavity of the blower box and faces away from the surface with the nozzle openings and faces the glass pane in the intended use. By means of the nozzle openings, the surface of a glass pane is intentionally impinged upon by an air flow. The nozzles can, advantageously, have a section linked to the entry opening and tapering in the direction of the outlet opening in order to guide the air into the respective nozzle efficiently and propitiously from a fluid mechanics standpoint.

According to the invention, the closure element is not rigidly connected to the stationary part of the blower box. Instead, the closure element is movable relative to the stationary part, and, in fact, away from the stationary part and vice versa toward the stationary part. The distance between the closure element and the stationary part is thus variable. When the nozzle openings are to be brought near a glass pane for prestressing, it is thus no longer necessary to move the entire blower box. Instead, the stationary part can remain unmoved and only the closure element is brought near the glass pane by increasing its distance from the stationary part. After prestressing, the closure element is again moved away from the glass pane by reducing its distance from the stationary part, and the glass pane can be moved out of the intermediate space between the blower boxes. In order to maintain the gas flow between the cavity and the closure element, the closure element is connected to the stationary part via a connection element that has a variable length. The connection element can thus adapt to the distance set in each case between the closure element and the stationary part.

For prestressing bent glass panes, closure elements that are adapted in terms of their contour to the glass pane are used in order to ensure substantially the same small distance between the glass pane and the nozzles over the entire pane surface. In prior art blower boxes, the closure element is directly connected to the other blower box with the cavity. Consequently, the contour of the outlet opening of the cavity must be precisely adapted to the contour of the closure element. As a result, the entire blower box is suitable only for a specific type of pane. If the production line is to be converted to a different type of pane with a different curvature, the entire blower boxes must be changed out.

In contrast, the present invention enables flexible use of the blower boxes. Since the closure element is not connected directly to the stationary part of the blower box, but via the connection element of variable length, it is no longer necessary with the blower box according to the invention for the contour of the outlet opening of the cavity to be precisely adapted to the contour of the closure element. This makes it possible to outfit the same stationary part of the blower box with different closure elements. If the type of pane to be prestressed is to be changed, it is, consequently, no longer necessary to change out the complete blower box. Instead, only the closure element has to be changed. As a result, tool costs and the necessary storage space are significantly reduced because, for each pane type, only a set of closure elements has to be manufactured and stored instead of a complete blower box. In addition, the effort during conversion is reduced. The prestressing apparatus is also simplified and more energy efficient because the movement of the relatively light closure element is mechanically less burdensome than the movement of heavy blower boxes such that, mechanically, fewer strong adjustment elements are necessary. These are major advantages of the present invention.

The relative arrangement of the totality of all nozzles with regard to one another is preferably constant and invariable. The area spanned by the totality of all nozzle openings is thus fixed and does not change with the movement of the at least one closure element. The closure element or the totality of all closure elements is suitable for simultaneously impinging upon the glass pane by the totality of all nozzles with the cooling gas flow.

The invention is applicable to various types of blower boxes. In a first embodiment, the closure element is a nozzle plate. The blower box has, in this case, only a single closure element. The nozzle plate is an element, typically a metal sheet that has the totality of the nozzles of the blower box. The nozzles are implemented as bores or passages through the plate. The nozzles are arranged in the plate in the manner of a two-dimensional pattern, for example, in multiple rows and multiple columns. The individual nozzle plate is connected to the stationary part of the blower box by means of a single connection element of variable length in order to complete the cavity. This type of blower box is relatively simply constructed and, consequently, economical to produce.

The nozzle plate can be smooth or corrugated, with, in the corrugated design, the nozzles preferably arranged on the crests of the waves. The troughs of the waves then provide drain channels for the outflowing gas.

In a second embodiment, nozzle strips are used as closure elements, as is customary with more complex blower boxes, with which higher prestressing efficiency can be achieved. In this case, a plurality of channels are connected to the cavity, typically opposite the gas feed line, into which channels the gas flow is divided during operation. Within the stationary part of the blower box, there is thus a transition from the cavity into a plurality of channels in order to divide the gas flow out of the cavity into the channels. The channels can also be referred to as nozzle webs, fins, or ribs. The channels typically have an elongated, substantially rectangular cross-section, wherein the longer dimension substantially corresponds to the width of the cavity and the shorter dimension is in the range from 8 cm to 15 cm. Typically, the channels are arranged parallel to one another. The number of channels is typically from 10 to 50. The channels are typically formed from sheet metal.

The cavity is preferably wedge-shaped. The boundary of the cavity adjacent the channels can be described as two side surfaces that converge in an acute angle. The channels typically extend perpendicular to the connection line of said side surfaces. Consequently, the length of a channel is not constant, but, instead, increases from the centre to the sides such that the inlet opening of the channel connected to the cavity is wedge-shaped and spans the outlet opening in a smooth, typically curved surface. The outlet openings of all channels typically form a common smooth, curved surface. As a result of the wedge-shaped embodiment of the cavity described and the arrangement of the channels described, the gas flow is particularly efficiently divided into the channels and this yields a very homogeneous gas flow over the entire effective area.

On its end opposite the cavity, each channel is completed with a nozzle strip. However, according to the invention, this connection is not rigid. Instead, each nozzle strip is connected to the channel associated therewith (i.e., the channel with which it is connected and which it completes) via a connection element that has a variable length. The connection element can thus adapt to the distance set in each case between the nozzle strip and the channel. Thus, a separate connection element and a nozzle strip are associated with each channel.

The nozzle strip has a plurality of passages that are referred to as nozzles. The gas flow of the channel is again divided by the nozzles of the nozzle strip. The nozzle strip preferably has a single row of nozzle openings that are arranged substantially along a line. The row of nozzle openings preferably extends over at least 80% of the length of the nozzle strip.

All nozzle strips of a blower box are preferably connected to one another rigidly such that they can be moved together. The connection can, for example, be achieved via one or a plurality of cross-braces or by a circumferential frame-like bracket. Using the means for moving the closure element, all of the nozzle strips are then moved simultaneously, with the required relative arrangement of the nozzle strips established and fixed by the cross-braces or the bracket.

The at least one connection element of variable length can be attached directly or indirectly to the associated closure element. In the case of an indirect connection, an additional element, for example, a gas channel or fixing element for the closure element, is arranged between the actual closure element, i.e., the nozzle plate or a nozzle strip, and the connection element. The connection element is then attached to the additional element, which is, in turn, connected to the closure element. The fixing element can, for example, be a fixing rail into which the closure element is inserted.

The following statements relate, unless otherwise indicated, to the invention in a general form regardless of whether the closure element is implemented as a nozzle plate, nozzle strip, or in a different manner.

The closure element preferably contains aluminium or steel and is preferably made of said materials. These materials are easy to work with and provide advantageous stability in long-term use. The closure element can, however, also contain or be made of a plastic, which is preferably stable up to a temperature of approx. 250° C. The plastic must have the necessary temperature stability for the intended use; the outflowing gas has temperatures of over 200° C. Suitable plastics are, for example, ethylene-propylene copolymers (EPM), polyimide, or polytetrafluoroethylene (PTFE).

The nozzle openings preferably have a diameter of 4 mm to 15 mm, particularly preferably of 5 mm to 10 mm, most particularly preferably of 6 mm to 8 mm, for example, 6 mm or 8 mm. The distance between adjacent nozzle openings is preferably from 10 mm to 50 mm, particularly preferably from 20 mm to 40 mm, for example, 30 mm. This yields good prestressing results. Here, “distance” refers to the distance between the respective centres of the nozzle openings.

The length and width of the closure element is governed by the design of the blower box. Typical values for the length of a nozzle strip (measured along the extension direction of the row of nozzles) are from 70 cm to 150 cm; and for the width/depth (measured perpendicular to the length in the plane of the nozzle openings), from 8 mm to 15 mm, preferably from 10 mm to 12 mm. Typical values for the length of a nozzle plate are likewise from 70 cm to 150 cm; and for the width, from 20 cm to 150 cm.

The blower box is also equipped with means for moving the closure element or the closure elements, in order to change the distance of the at least one closure element from the stationary part. For this, cylinders that are driven by actuator motors, for example, servomotors, can be used; they have the advantage that they can be moved very quickly and accurately. However, alternatively, pneumatically or hydraulically driven cylinders, for example, can be used. In plan view, the outlet opening of the stationary part of a blower box is typically quadrangular, in particular rectangular or trapezoidal, such that four drive cylinders are preferably used, one of which is arranged in each case at a corner of the blower box. However, depending on the intended use, other geometries of the outlet opening are also conceivable, for example, round or oval outlet cross-sections.

The means for moving the closure element are, in particular, suited to change the distance of the closure element or of all the closure elements from the stationary part without changing the relative arrangement of the nozzles with respect to one another. The area spanned by all the nozzle openings of a blower box, which is preferably adapted to the shape of the glass pane to be prestressed, thus remains constant during the movement of the closure element. In a particularly advantageous embodiment, said area is three-dimensional, i.e., curved along both spatial directions. This can also be referred to as spherical curvature.

The means for moving the closure element are in particular suitable and intended to bring the at least one closure element near each glass pane to be prestressed and, following the prestressing, to move it away from the pane again; preferably, the closure element is brought near the next glass pane to be prestressed. The movement of the closure element or all of the closure elements is preferably done simultaneously.

The connection element of variable length is a bellows in a preferred embodiment. In order not to substantially weaken the gas flow, the bellows should be made from a material with the least possible gas permeability. Suitable materials are, for example, canvas, leather, or even steel that is shaped like a spring or is implemented as a woven fabric. The thickness of the material of the bellows is preferably from 0.2 mm to 5 mm, particularly preferably from 0.5 mm to 3 mm, as a result of which, on the one hand, adequate stability and mechanical durability as well as good gas-tightness are ensured, along with, on the other, advantageous flexibility and shapeability. In the case of a nozzle plate as a closure element, a single bellows is used, attached, on one side, in the region of the circumferential side edge of the nozzle plate or to another element situated between the connection element and the nozzle plate; and, on the other side, in the region of the outlet opening of the cover that surrounds the cavity of the stationary part. In the case of nozzle strips as closure elements, a separate bellows is used for each nozzle strip, which bellows is situated, on one side, in the region of the circumferential side edge of the nozzle strip or on another element situated between the connection element and nozzle strip, and, on the other side, is attached in the region of the outlet opening of the associated channel boundary.

In another preferred embodiment, the connection element is implemented as a rigid tube and the connection element and the stationary part of the blower box are telescopically guided into one another and displaceable relative to one another in order to make the distance between the closure element and the stationary part variable. The tube typically has a quadrangular cross-section, corresponding to the shape of the nozzle plate or the nozzle strip. The tube is typically formed from a metal sheet, for example, of steel or aluminium, and preferably has a wall thickness from 0.5 mm to 3 mm. In the case of a nozzle plate as a closure element, a single tube is used, which is, on one side, directly or indirectly connected to the region of the circumferential side edge of the nozzle plate. On the other side, the tube is inserted into the cover that surrounds the cavity of the stationary part such that it protrudes into the cover and the cavity; or, alternatively, is plugged onto the cover such that the cover protrudes into the tube. In the case of nozzle strips as closure elements, a separate tube is used for each nozzle strip, which tube is plugged into the associated channel outlet such that it protrudes into the channel, or, alternatively, is plugged onto the associated channel outlet such that the channel boundary protrudes into the tube. The variant in which the cover of the stationary part or the channel boundaries protrude into the tube or tubes can be preferable because, in this case, the flow cross-section for the gas flow is expanded in the transition from the stationary part to the connection element, resulting in lower flow losses. In any case, the tube and the associated stationary part should be arranged as flush as possible with the least possible distance between them in order not to cause a significant pressure drop of the gas flow.

If a rigid tube is used as the connection element, a bellows that surrounds the telescopic construction can also be used in addition. The bellows serves in this case not as a connection element of variable length, but, rather, serves to protect the telescopic construction from dirt or moisture.

The invention also includes an apparatus for thermal prestressing of glass panes. The apparatus comprises a first blower box according to the invention and a second blower box according to the invention, which are arranged opposite one another such that their closure elements and their nozzles face one another. The blower boxes are spaced apart from one another such that a glass pane can be arranged therebetween. Typically, the nozzles of the first blower box (upper blower box) point substantially downward and the nozzles of the second blower box (lower blower box) point substantially upward. Then, a glass pane can advantageously be moved in a horizontal position between the blower boxes. The nozzles are aligned roughly perpendicular to the glass surface.

The apparatus also includes means for moving a glass pane, which are suitable for moving a glass pane into the intermediate space between the two blower boxes and out of said intermediate space again. A rail, roller, or conveyor belt system, for example, can be used for this. In a preferred embodiment, the means for moving the glass pane also include a frame mould, on which the glass pane is mounted during transport. The frame mould has a circumferential, frame-like support surface, on which the side edge of the glass pane rests, whereas the greater part of the pane surface.

The blower boxes themselves, i.e., their stationary parts are, according to the invention, not intended to be moved during the prestressing. The apparatus can, however, include means for changing the distance between the first and the second blower box, for example, servomotors, such that they can be moved away from each other. The distance between the blower boxes can then be enlarged, for example, for maintenance purposes or for retrofitting the closure element.

The apparatus is, in particular, suitable and intended to bring the closure elements nearer each glass pane to be prestressed that is arranged in the intermediate space between the blower boxes, and to again distance the closure elements from the glass pane following the prestressing (in other words, to enlarge the distance of the closure element from the glass pane) in order to move the glass pane out again from the intermediate space between the blower boxes. The movement of the closure element or of all the closure elements of a blower box is preferably done simultaneously. The apparatus is, in particular, suitable and intended to impinge upon the glass pane with the cooling gas flow by all the nozzles of the blower boxes simultaneously.

The relative arrangement of the nozzle openings of the blower boxes is preferably adapted to the shape of the pane to be prestressed. The nozzle openings of one blower box span a convexly curved area and the nozzle openings of the opposite blower box span a concavely curved area. These areas preferably remain constant during the movement of the closure elements; the relative arrangements of the nozzles of a blower box to one another thus does not change. The totality of all nozzles of a blower box is simultaneously moved toward the glass pane or away from the glass pane, without their arrangement relative to one another changing. The relative arrangement of the nozzles of a blower box to one another and the area spanned by their nozzle openings is thus identical in the state farther from the glass pane (in which the glass pane is transported in or out) and in the near state (in which the actual prestressing is done). The sharpness of the curvature is also governed by the shape of the pane. During prestressing, the convex blower box faces the concave surface of the pane and the concave blower box faces the convex surface. Thus, the nozzle openings can be positioned nearer the glass surface, increasing the prestressing efficiency. Since the panes are usually transported to the prestressing station with an upward facing concave surface, the upper blower box is preferably convex and the lower one is concave. The distance of the nozzle outlets from the glass surface can be set precisely to a desired value by the means for moving the at least one closure element.

The apparatus is preferably suitable and intended to prestress three-dimensionally bent glass panes (i.e., bent along both spatial directions). Such glass panes can also be referred to as as spherically curved in contrast to cylindrically curved glass panes that are bent along only one spatial direction.

The invention also includes an arrangement for thermal prestressing of glass panes, comprising the apparatus according to the invention and a glass pane arranged between the two blower boxes.

The invention also includes a method for thermal prestressing of a glass pane, wherein
(a) a heated glass pane having two primary surfaces and a circumferential side edge is arranged areally between a first blower box according to the invention and a second blower box according to the invention such that the two primary surfaces can be impinged upon by a gas flow,
(b) then, the closure elements of the two blower boxes are brought near the glass pane, and
(c) then, the two primary surfaces of the glass pane are impinged upon by a gas flow by means of the two blower boxes such that the glass pane is cooled.

After the prestressing, the closure elements of the two blower boxes are again moved away from the glass pane. Subsequently, the glass pane is moved out of the intermediate space between the glass panes. The method is not a continuous method in which the glass panes are continuously moved through the intermediate space between the blower boxes without dwelling there. Instead, the glass pane is arranged in the intermediate space, remains there during the prestressing, and is, thereafter, moved again out of the intermediate space. Then, the next glass pane can be arranged between the blower boxes. The movement of the closure elements toward the glass pane and, subsequently, away from the glass pane again is done separately for each individual glass pane. The movement of the closure element or of the totality of all the closure elements of a blower box is preferably done simultaneously. During the prestressing, the glass pane is impinged upon simultaneously with the cooling gas flow by the totality of all nozzles of the blower boxes.

During the actual prestressing, the glass pane is typically moved oscillatingly back and forth such that the air flow exiting one nozzle does not always impinge on the same location of the glass pane, but, rather, a more homogeneous distribution of the cooling effect over the pane surface is achieved.

Preferably, in step (b), only the closure elements of the blower boxes are moved, whereas the stationary parts of the blower boxes remain unmoved and stationary.

The glass pane is preferably transported between the blower boxes on rollers, rails, or a conveyor belt. In an advantageous embodiment, the glass pane is arranged, for this, on a mould with a frame-like support surface (frame mould).

The impingement upon the pane surfaces with the gas flow is done by introducing a gas flow into the inner cavity of each blower box, dividing it there, and guiding it, uniformly distributed, onto the pane surfaces via the nozzle openings.

The gas used for the cooling of the glass pane is preferably air. The air can be actively cooled to increase the prestressing efficiency within the prestressing apparatus. Typically, however, air is used that is not specifically temperature controlled by active measures.

The pane surfaces are preferably impinged upon by the gas flow over a period of 1 s to 10 s.

The glass pane to be tempered is, in a preferred embodiment, made of soda lime glass, as is customary for window panes. The glass pane can, however, also include or be made of other types of glass such as borosilicate glass or quartz glass. The thickness of the glass pane is typically from 1 mm to 10 mm, preferably 2 mm to 5 mm.

The glass pane is preferably three-dimensionally bent, as is common for vehicle window panes. In the art, “a three-dimensional bend” means a bend along two (mutually orthogonal) spatial directions, i.e., a bend along the height dimension of the glass pane and a bend along the width dimension of the glass pane. Bent, prestressed panes are, in particular, common in the vehicle sector. The glass pane to be prestressed according to the invention is, consequently, preferably intended as a window pane of a vehicle, particularly preferably of a motor vehicle, and, in particular, of a passenger car.

The closure elements are adapted to the pane shape such that each nozzle of a blower box preferably is substantially the same distance from the pane surface. During the displacement of the closure elements, the relative arrangement of the nozzles to one another does not change, but, rather, the totality of all nozzles of a blower box is simultaneously moved toward the glass pane or away from the glass pane. The area spanned by the totality of all nozzle openings, which preferably corresponds substantially to the shape of the pane surface, thus remains constant during the movement of the closure elements and is moved as a whole toward the glass pane and away from the glass pane.

In an advantageous embodiment, the method according to the invention immediately follows a bending process in which the glass pane, planar in the initial state, is bent. During the bending process, the glass pane is heated to softening temperature. The prestressing process follows the bending process before the glass pane is significantly cooled. Thus, the glass pane does not need to be heated again specifically for prestressing.

The invention also includes the use of a glass pane prestressed with the method according to the invention in means of transport for travel on land, in the air, or on water, preferably as a window pane in rail vehicles or motor vehicles, in particular as a rear window, side window, or roof panel of passenger cars.

The invention is explained in detail in the following with reference to drawings and exemplary embodiments. The drawings are schematic representations and not true to scale. The drawings in no way restrict the invention. In particular, the number of nozzles and channels of the blower boxes are not depicted true to reality, but merely serve to illustrate the principle.

They depict:

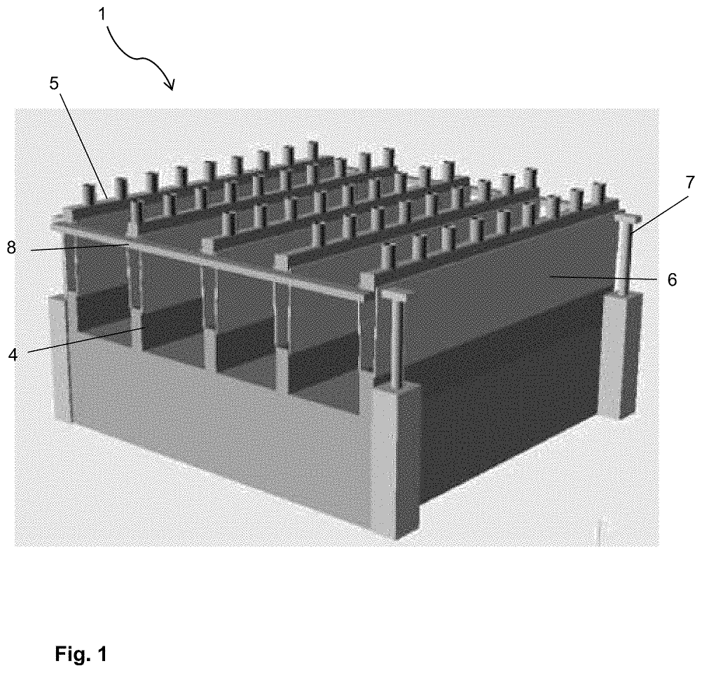

FIG. 1 a perspective view of a first embodiment of the blower box according to the invention,

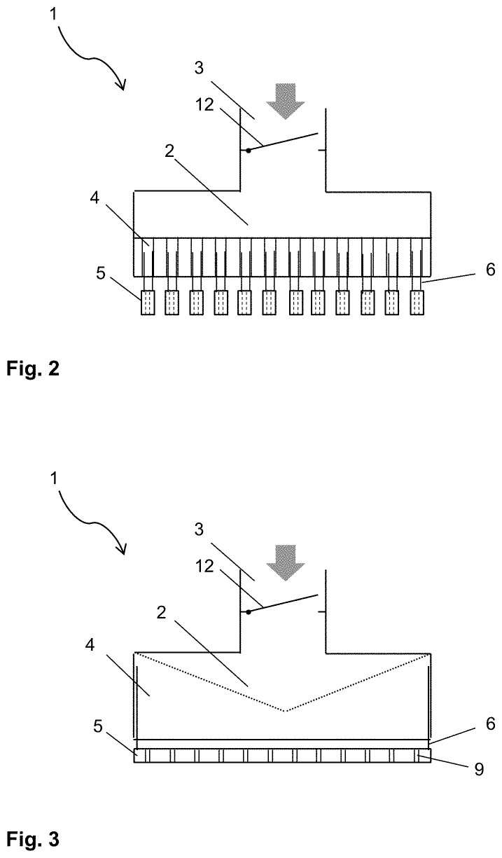

FIG. 2 a cross-section perpendicular to the nozzle strips through a blower box according to the invention,

FIG. 3 a cross-section lengthwise of the nozzle strips through a blower box according to the invention,

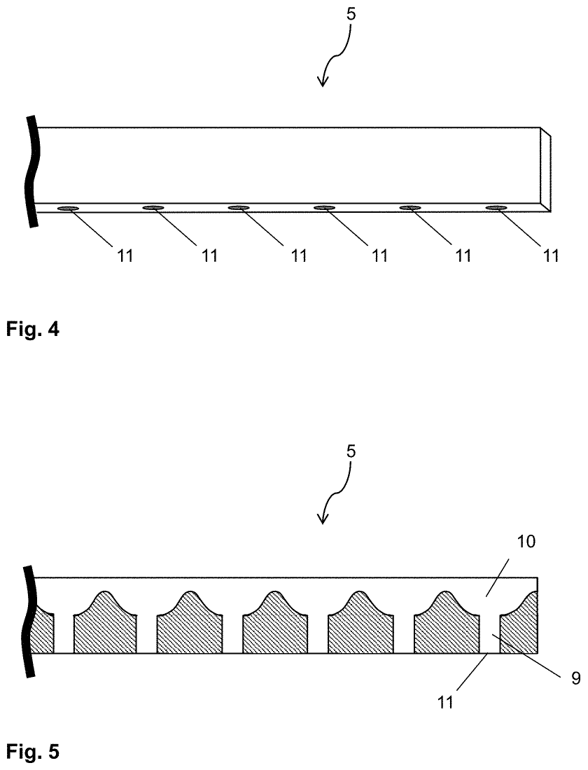

FIG. 4 a perspective view of a nozzle strip,

FIG. 5 a cross-section through the nozzle strip of FIG. 4,

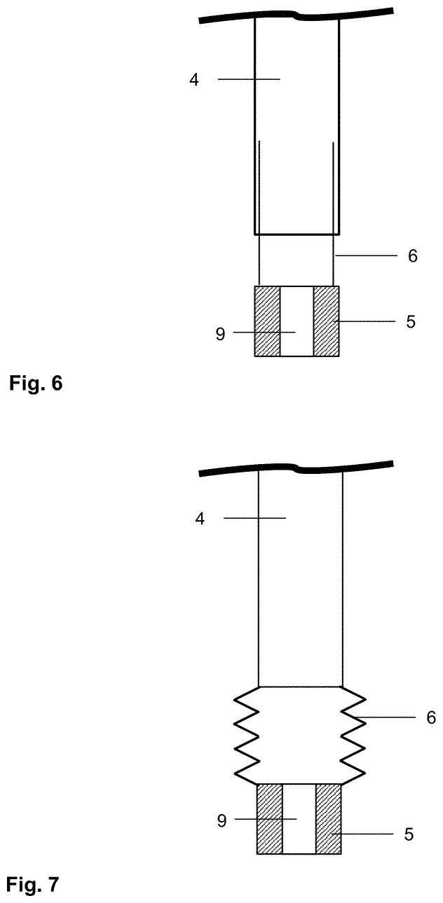

FIG. 6 a detailed view of a single channel with a nozzle strip and a first embodiment of the connection element,

FIG. 7 a detailed view of a single channel with a nozzle strip and a second embodiment of the connection element,

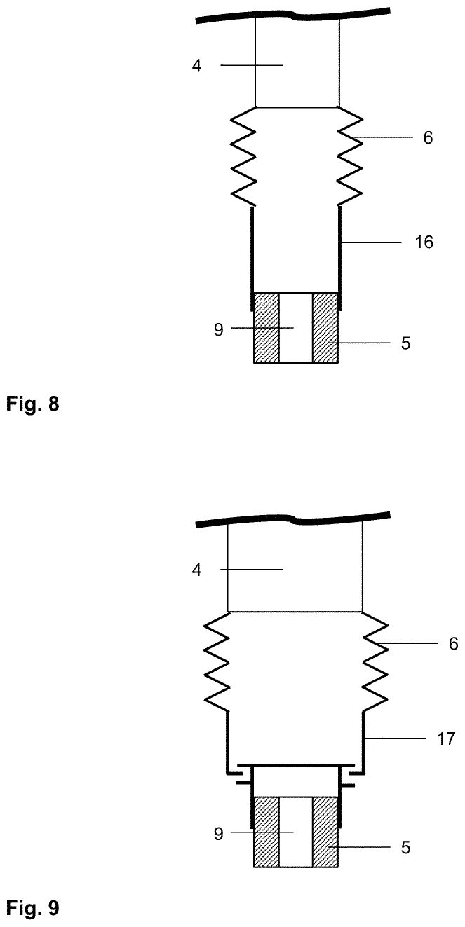

FIG. 8 a detailed view of a single channel with a nozzle strip in another embodiment of the invention,

FIG. 9 a detailed view of a single channel with a nozzle strip in another embodiment of the invention,

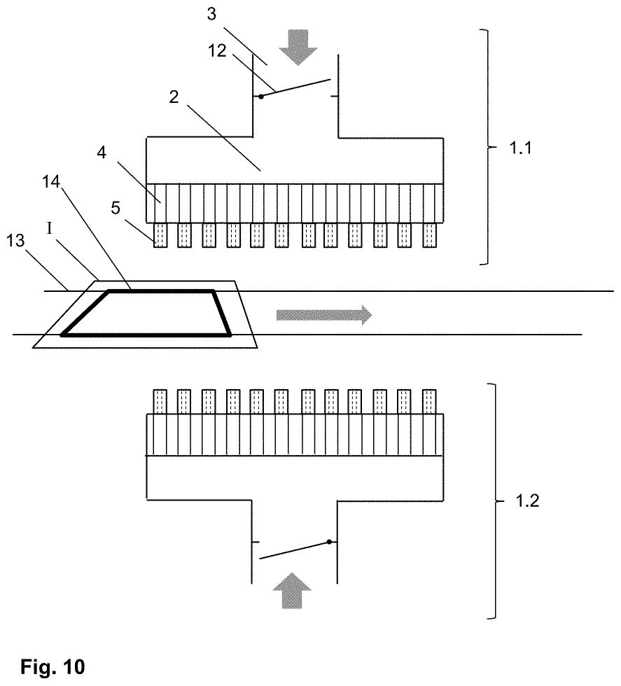

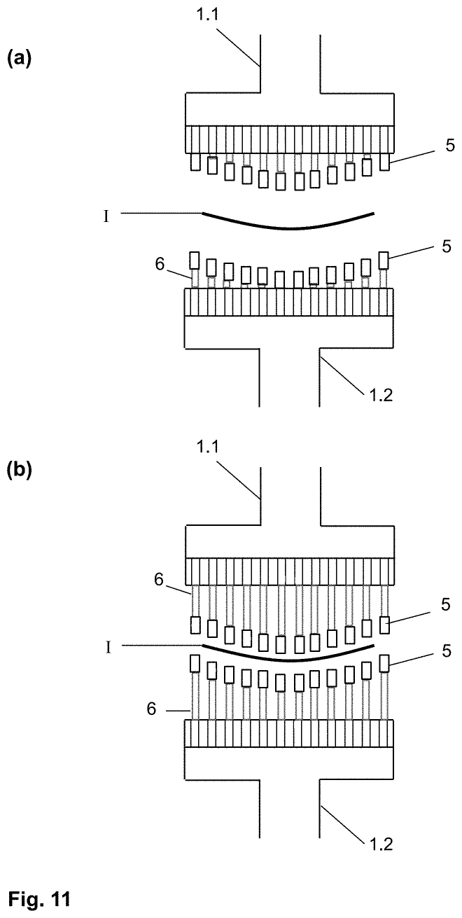

FIG. 10 a cross-section through two blower boxes according to the invention as part of an apparatus according to the invention for thermal prestressing,

FIG. 11 a cross-section through an apparatus according to the invention during a prestressing operation

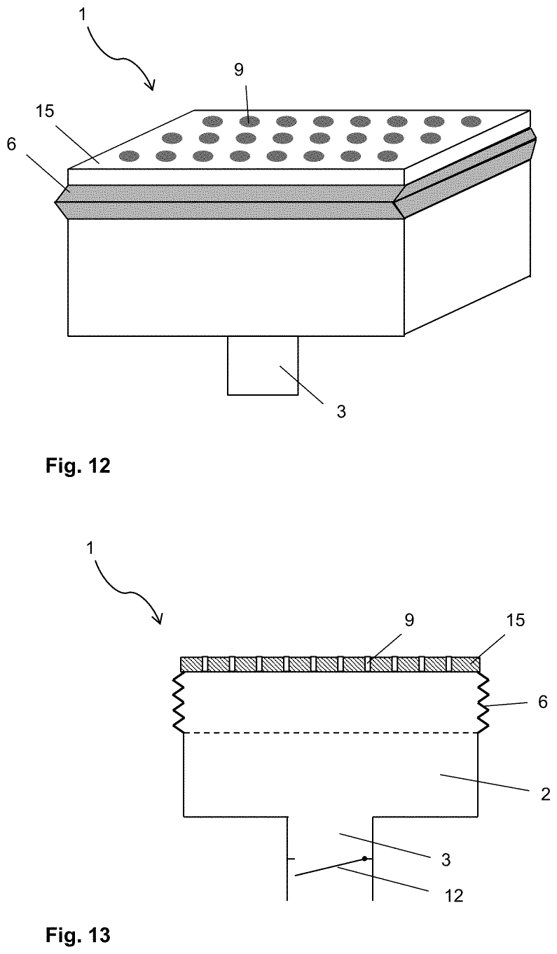

FIG. 12 a perspective view of another embodiment of the blower box according to the invention,

FIG. 13 a cross-section through the blower box of FIG. 12, and

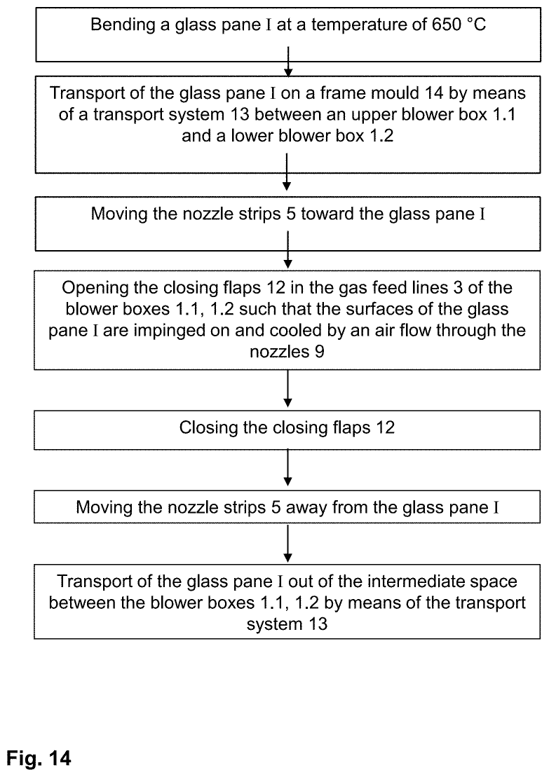

FIG. 14 a flowchart of an embodiment of the method according to the invention.

FIG. 1 depicts a perspective view of an embodiment of the blower box 1 according to the invention for thermal prestressing of glass panes. The blower box 1 has an inner cavity, out from which channels 4 extend. The outlet opening of each channel 4 is connected via a connection element 6 of variable length to a nozzle strip 5 that functions as a closure element and completes the channel 4. The connection elements 6 are manufactured as tubes from a steel sheet with a material thickness of, for example, 1.5 mm. Each connection element 6 is telescopically connected to the associated channel 4: connection element 6 and the boundary of the channel 4 are thus guided into one another and are displaceable relative to one another. The nozzle strips 5 are rigidly connected to each other by cross-braces 8 and movable together in order to change the distance between the nozzle strips 5 and the channels 4, with the connection elements 6 of variable length ensuring that the gas flow out of blower box 1 is maintained. In order to set the desired distance between nozzle strips 5 and channels 4, the blower box 1 has means 7 for moving the nozzle strips 5. These are realised in the form of four servomotors that are in each case arranged at a corner of the blower box 1, and they drive cylinders that are connected to a nozzle strip 5 or to the cross-brace 8. A movement of the cylinder displaces the totality of the nozzle strips 5 away from or toward the blower box 1.

The nozzle strips 5 are depicted straight for simplicity and improved clarity. However, for prestressing bent vehicle windows, bent nozzle strips 5 are used in reality, wherein the curved area that is spanned by the nozzle openings is adapted to the contour of the glass pane. When the glass pane is positioned as intended relative to the blower box 1, the nozzle strips 5 can be brought near the glass pane surface by the servomotors and displaceable cylinders, with the stationary part of the blower box 1 remaining stationary. For moving the relatively light nozzle strips 5, significantly less powerful servomotors are necessary than for moving the entire blower box 1, as is common with prior art apparatuses. The blower box is, consequently, more economical. In addition, the stationary part of the blower box 1 can be used as a universal tool, wherein during conversion to a different pane type, only the nozzle strips 5 with the connection elements 6 have to be changed out. It is thus not necessary to produce and store a separate blower box for each type of pane and to reinstall one with each retooling. This, as well, it is advantageous in terms of costs and flexibility of the prestressing apparatus.

FIG. 2 and FIG. 3 depict cross-sections through a blower box 1 according to the invention similar to that of FIG. 1, wherein the cut surface in FIG. 2 extends perpendicular to the channels 4 and in FIG. 3 lengthwise of the channels 4. The blower box 1 is of the type that is described, for example, in DE 3924402 C1 or WO 2016054482 A1. The blower box 1 has an inner cavity 2, into which an air flow, represented in the figures by a grey arrow, is guided via a gas feed line 3. The air flow is generated, for example, by two fans (not shown) connected in series that are connected to the blower box 1 via the gas feed line 3. The air flow can be interrupted by a closing flap 12 without having to turn off the fans.

Opposite the gas feed line 3, channels 4, through which the air flow is divided into a row of partial flows, connect to the cavity 2. The channels 4 are implemented in the manner of a hollow rib that is substantially as long as the cavity 2 in one dimension and have, in the dimension perpendicular thereto, a significantly small width, for example, approx. 11 mm. The channels 4 with their elongated cross-section are arranged parallel to one another. The number of channels 4 depicted is not representative and serves only to illustrate the operating principle.

The cavity 2 is wedge-shaped—along a first dimension, the depth of the cavity 2 is greatest in the centre of the blower box and decreases outward in both directions. In the second dimension, perpendicular thereto, the depth at a given position of the first dimension remains constant in each case. The channels 4 are connected to the wedge-shaped cavity 10 along said first dimension. Consequently, they have a depth profile complementary to the wedge shape of the cavity 2, wherein the depth is least in the centre of the channel 4 and increases outward such that the air outlet of each channel 14 forms into a smooth, planar, or curved surface.

FIG. 2 and FIG. 3 depict two cross-sections with an angle of 90° relative to one another. FIG. 2 depicts a cross-section along said second dimension of the blower box 1 transverse to the orientation of the channels 4 such that the individual channels 4 are discernible in the cross-section. The depth of the cavity 2 is constant in the sectional plane. FIG. 3 depicts a cross-section along said first dimension of the blower box 1 along the orientation of the channels 4. Here, the wedge-like depth profile of the cavity 2 is discernible, whereas only one single channel 4, whose depth profile is likewise discernible, lies in the sectional plane.

Each channel 4 is completed on its end opposite the cavity 2 with a nozzle strip 5. Here as well, the nozzle strips 5 are depicted straight for the sake of simplicity, although, in reality, they are curved. The nozzle strip 1 again divides the air flow of each channel 4 into further partial flows, which are fed in each case through a nozzle 9. In order to be able to vary the distance of the nozzle strips 5 from the channels and and to nevertheless maintain the intended air flow, the nozzle strips 5 are connected to the channels via connection elements 6 of variable length. The connection elements 6 are implemented as tubes made of sheet steel that are telescopically connected to the channels.

FIG. 4 and FIG. 5 each depict a detail of an embodiment of the nozzle strip 5 according to the invention for a blower box 1 for thermal prestressing of glass panes, depicted straight instead of curved here again for the sake of simplicity. The nozzle strip 5 is made of aluminium, which can be readily processed and has advantageously low weight. The nozzle strip has, for example, a width of 11 mm, with the dimensions coordinated to complete the gas channels 4 of an associated blower box 1. As usual with generic nozzle strips, the nozzle strip 5 according to the invention is also implemented with a row of nozzles 9. Each nozzle 9 is a passage (bore) between two opposite side surfaces of the nozzle strip 5. The nozzles 9 are intended to feed a gas flow out of the associated blower box 1, wherein the gas flow enters the nozzle 9 via a nozzle inlet 10 and exits the nozzle 9 via a nozzle opening 11. The side surface of the nozzle strip 9 with the nozzle inlets 10 must, consequently, face the blower box 1 in the installation position, whereas the side surface with the nozzle openings 11 faces away from the blower box.

The individual nozzles 9 have a greatly widened nozzle inlet 10, followed by a tapering section. Thereafter, the diameter of the nozzle remains constant at 6 mm all the way to the nozzle opening 11.

FIG. 6 depicts a cross-section of a single channel 4 with an associated nozzle strip 5, which are telescopically connected to one another. For this, the connection element 6 is implemented as a tube and plugged into the channel 4 such that it is displaceable relative to the channel 4. Alternatively, it is also possible to plug the tube onto the channel such that it is arranged outside the channel boundary. The latter variant can even be preferable because, then, a cross-sectional narrowing in the flow direction, as depicted, does not occur and the gas flow is interfered with less.

FIG. 7 depicts a cross-section of a single channel 4 and an associated nozzle strip 5, which are connected to one another by means of a bellows as a connection element 6. The bellows is connected on one side to the nozzle strip 5 and on the other side to the outlet opening of the channel 4. The bellows is made of canvas with a material thickness of 0.5 mm. Thus, sufficient gas-tightness to maintain the air flow largely without interference is achieved.

In the exemplary embodiments of FIGS. 6 and 7, the connection element 6 is directly attached to the nozzle strip 5.

FIG. 8 depicts a cross-section of a single channel 4 and an associated nozzle strip 5 in another embodiment. In contrast to FIG. 7, the bellows, as connection element 6, is not attached directly to the nozzle strip 5. Instead, a gas channel formed from metal sheets is arranged between the connection element 6 and the nozzle strip 5. The connection element 6 is attached to the end of the metal sheets, whereas the opposite end of the metal sheets is attached to the nozzle strip. The gas channel 16 is moved together with a nozzle strip.

FIG. 9 depicts a cross-section of a single channel 4 and an associated nozzle strip 5 in another embodiment. Here again, the bellows, as connection element 6, is not attached directly to the nozzle strip 5. Instead, the connection element 6 is attached to a fixing element 17 for the nozzle strip 5. The fixing element 17 is implemented in the manner of a fastening rail, into which the nozzle strip is inserted. For this, the nozzle strip is equipped with a complementary rail element. This rail element can be made in one piece with the nozzle strip or, as shown, be attached to the nozzle strip as a separate element.

FIG. 10 depicts an embodiment of the apparatus according to the invention for thermal prestressing of glass panes. The apparatus comprises a first, upper blower box 1.1 and a second, lower blower box 1.2 that are arranged opposite one another such that the nozzle openings 11 of the nozzle strips 5 are directed at one another. The apparatus further comprises a transport system 13, with which a glass pane I to be prestressed can be transported between the blower boxes 1.1, 1.2. The glass pane I is held horizontally on a frame mould 14, which has a frame-like support surface on which a circumferential edge region of the glass pane I is placed. The transport system 13 consists, for example, of rails or a roller system, on which the frame mould 14 is movingly held. The glass pane I is, for example, a pane made of soda lime glass that is intended as a rear window for a passenger car. The glass pane I has passed through a bending process wherein it had been been brought at a temperature of approx. 650° C., for example, by gravity bending or press bending into the intended, bent shape. The transport system 13 serves to transport the glass pane I, in the still heated state, from the bending apparatus to the prestressing apparatus. There, the two primary surfaces are impinged upon by an air flow by the blower boxes 1.1, 1.2 in order to cool them greatly and, thus, to generate a characteristic profile of tensile and compressive stresses. The thermally prestressed glass pane I is suitable as so-called “single-pane safety glass” for use as an automobile rear window. After prestressing, the pane is again transported by the transport system 13 out of the intermediate space between the blower boxes 1.1, 1.2, making the prestressing apparatus available for prestressing the next glass pane. The transport direction of the glass pane I is represented by a grey arrow.

FIG. 11 depicts an apparatus according to the invention in steps during the prestressing method according to the invention. The glass pane I to be prestressed is three-dimensionally bent, as is common in the motor vehicle sector. Consequently, it is necessary to move the nozzles 9 of the blower boxes 1.1, 1.2: from a state farther apart in which the glass pane I can be moved into the intermediate space, into a state in which the nozzle openings 11 are at a distance from the glass surface that is as small as possible and substantially constant over the surface of the pane. In prior art apparatuses, this movement occurs through raising and lowering the entire blower boxes with powerful servomotors.

In contrast, with the apparatus according to the invention, the entire blower boxes 1.1, 1.2 do not have to be moved, only the nozzle strips 5. Initially, the nozzle strips 5 of the two blower boxes are spaced far apart such that there is a large intermediate space into which the glass pane I can be easily transported in (FIG. 11a). When the glass pane I is positioned, the nozzle strips 5 are moved toward the glass pane I (FIG. 11b). All nozzle strips 5 are then arranged at a short distance from the glass surface and the glass pane I is impinged upon by the air flow for prestressing. Then, the nozzle strips 5 are again moved away from the glass pane I such that it can be transported out of the intermediate space.

In the figure, it is readily discernible that due to the bowl-shaped, three-dimensional curvature of the glass pane I, it would have been impossible to move it into the intermediate space in the final state of the nozzle strips, as a result of which movement of the nozzles is necessary.

FIG. 12 and FIG. 13 each depict a detail of a blower box 1 with a simpler design, to which the invention is also applicable. Here, the stationary part of the blower box 1 comprises a cover, within which a cavity 2 is formed and to which a gas feed line 3 is connected. Within the stationary part, no division of the gas flow into channels 4 is done, but, rather, the cover has an opening with a large cross-section opposite the gas feed line 3. Used as a movable closure element is a single nozzle plate 15, which closes the large opening and is provided with a two-dimensional pattern of nozzles 9. The nozzle plate 15 is connected to the stationary part by means of a single bellows as connection element 6 of variable length.

The nozzle plate 15 is also depicted planar here for the sake of simplicity, although, in reality, nozzle plates that are adapted to the contour of the curved vehicle panes, i.e., are also bent three-dimensionally, are used.

In the embodiment depicted, the connection element 6 is attached directly to the nozzle plate 15. However, it is also possible here for additional elements to be arranged between the connection element 6 and the nozzle plate 15, for example, a gas channel 16 formed by metal sheets or eine fixing element 17 for the nozzle plate, as depicted in FIGS. 8 and 9 in connection with a nozzle strip 5.

FIG. 14 represents an exemplary embodiment of the method according to the invention for thermal prestressing of glass panes with reference to a flowchart using an apparatus according to FIGS. 10 and 11.

### LIST OF REFERENCE CHARACTERS

(1) blower box
(1.1) first/upper blower box
(1.2) second/lower blower box
(2) cavity of the blower box 1, 1.1, 1.2
(3) gas feed line of the blower box 1, 1.1, 1.2
(4) channel/nozzle web of the blower box 1, 1.1, 1.2
(5) nozzle strip (as a closure element)
(6) connection element of variable length
(7) means for moving the closure elements
(8) cross-brace of the nozzle strips 5
(9) nozzle
(10) nozzle inlet/inlet opening of the nozzle 9
(11) nozzle opening/outlet opening of the nozzle 9
(12) closing flap in the gas feed line 3
(13) transport system for glass panes
(14) frame mould for glass panes
(15) nozzle plate (as a closure element)
(16) gas channel between the connection element 6 and the closure element
(17) fixing element between the connection element 6 and the closure element
(I) glass pane

1. Blower box for thermal prestressing of glass panes, comprising
a stationary part having a cavity and a gas feed line connected to the cavity,
and
at least one closure element having a plurality of nozzles connected to the cavity for applying an air flow to a surface of a glass pane,
wherein
the at least one closure element is connected to the stationary part at least via a connection element of variable length,
the at least one closure element is movable relative to the stationary part such that a distance between the closure element and the stationary part is variable, and
the blower box is equipped with means for moving the at least one closure element.

2. The blower box according to claim 1, wherein the connection element is a bellows.

3. The blower box according to claim 2, wherein the bellows is made of canvas, leather, or steel with a thickness of 0.5 mm to 3 mm.

4. The blower box according to claim 1, wherein the connection element is implemented as a rigid tube and wherein the connection element and the stationary part are telescopically guided into one another and displaceable relative to one another.

5. The blower box according to claim 4, wherein the tube is made of sheet metal with a material thickness of 0.5 mm to 3 mm.

6. The blower box according to claim 1, wherein the connection element is attached directly or indirectly to the closure element.

7. The blower box according to claim 1, which has a single closure element that is a nozzle plate and is connected to the stationary part by means of a single connection element.

8. The blower box according to claim 1, which has a plurality of channels connected to the cavity, which are in each case completed with a nozzle strip opposite the cavity as a closure element, wherein each nozzle strip is connected to the channel associated therewith via a connection element of variable length.

9. The blower box according to claim 8, wherein the nozzle strips are rigidly connected to one another such that the nozzle strips are movable together.

10. Apparatus for thermal prestressing of glass panes, comprising:
a first and a second blower box according to claim 1, which are arranged opposite one another such that the closure elements of the first blower box and of the second blower box point toward one another; and
means for moving a glass pane into an intermediate space between the first blower box and the second blower box.

11. The apparatus according to claim 10, wherein the means for moving the glass pane comprise a frame mould, on which the glass pane is arranged, and a transport system for moving the frame mould.

12. Method for thermal prestressing of a glass pane, comprising:
(a) areally arranging a heated glass pane having two primary surfaces and a circumferential side edge between a first and a second blower box according to claim 1 such that the two primary surfaces can be impinged upon by a gas flow;
(b) bringing the closure elements of the first and second blower boxes near the glass pane, and
(c) impinging a gas flow upon the two primary surfaces of the glass pane by means of the first and second blower boxes such that the glass pane is cooled.

13. The method according to claim 12, wherein in step (b), the stationary parts of the first and second blower boxes remain stationary.

14. The method according to claim 12, wherein the glass pane is bent along two spatial directions.

15. A method comprising utilizing a glass pane prestressed by the method according to claim 1 in means of transport for travel on land, in the air, or on water.

16. The method according to claim 15, wherein the glass pane is a window pane in a rail vehicle or a motor vehicle.

17. The method according to claim 15, wherein the glass pane is a rear window, a side window or a roof panel of a passenger car.
